(19) United States
(12) Patent Application Publication
(10) Pub. No.: US 2005/0026588 A1
(43) Pub. Date: Feb. 3, 2005

(54) Communication systems incorporating HTS filters and non-linear modulators such as RF-light modulators

(75) Inventors: Michael M. Eddy, Santa Barbara, CA (US); Steven M. Totty, Goleta, CA (US)

Correspondence Address: O'MELVENY & MEYERS, 114 PACIFICA, SUITE 100, IRVINE, CA, 92618, US

(73) Assignee: Superconductor Technologies, Inc., Santa Barbara, CA (US)

(21) Appl. No.: 10/422,917

(22) Filed: Apr. 23, 2003

Related U.S. Application Data
(63) Continuation-in-part of application No. 10/102,611, filed on Mar. 19, 2002, now abandoned.
(60) Provisional application No. 60/277,418, filed on Mar. 19, 2001.
(60) Provisional application No. 60/277,419, filed on Mar. 19, 2001.

(51) Int. Cl. H04B 1/10; H04B 1/18

(52) U.S. Cl. 455/307; 455/283; 455/550.1

(57) ABSTRACT

Methods, apparatus, and systems are provided for remoteable communication systems. More particularly, the inventions of this system include a remoteable or distributed communications system having a plurality of front ends located remotely from a base station. Each front end includes a receive side subsystem with an HTS filter, a non-linear modulator, and may also include a low noise amplifier coupled to the non-linear modulator. The non-linear modulator modulates a RF signal in light prior to transport via an optical transmission path to the base station. Because the modulator is placed in the front end, no down conversion is required prior to transport of a received signal.

### CROSS-REFERENCE TO RELATED APPLICATIONS

The present application is a continuation-in-part of co-pending U.S. application Ser. No. 10/102,611, entitled “Apparatus and methods for improved tower mountable systems for cellular communications,” filed Mar. 19, 2002, which claims priority under 35 U.S.C. § 119(e) from U.S. Provisional Application Ser. No. 60/277,418, entitled “Apparatus and methods for improved tower mount systems for cellular communications,” filed Mar. 19, 2001, now abandoned, and U.S. Provisional Application Ser. No. 60/277,419, entitled “Method and apparatus for combined receive and transmit subsystems in cellular communication systems,” filed Mar. 19, 2001, now abandoned, the disclosures of which are expressly incorporated herein by reference in their entireties.

### FIELD OF THE INVENTION

This invention relates generally to the field of telecommunications and cellular communications, such as, e.g., cellular telephone communications. More particularly, this invention relates to telecommunications and cellular communications systems that may include the use of high temperature superconducting (HTS) filters and non-linear modulators.

### BACKGROUND

Radio frequency (RF) equipment has used a variety of approaches and structures for receiving and transmitting radio waves and other signals in selected frequency bands. The type of filtering structure used often depends upon the intended use and the specifications for the radio equipment. For example, dielectric filters may be used for filtering electromagnetic energy in the ultra-high frequency (UHF) band, such as, e.g., those used for cellular communications in the 800+ MHz frequency range. Because of an increase in the number of users utilizing a limited bandwidth, demand has increased for greater frequency selectivity without degrading receiver sensitivity than can be provided by normal or non-superconducting resonator filters, especially for RF signals in the ultra-high frequency bands that may be used for cellular communications. As a result, substantial attention has recently been devoted to the development of HTS RF filters for use in, for example, cellular telecommunications systems, to accomplish and optimize high frequency selectivity.

When incorporating HTS filters, one important issue is heat dissipation. Stated somewhat differently, for an HTS filter system to function properly, the heat of compression generated by a cryocooler incorporated within the system must be efficiently and reliably rejected to the ambient environment. If the heat generated by the cryocooler cannot be efficiently and reliably rejected, the generated heat may have a serious impact upon system operation. Depending upon the circumstances, insufficient heat dissipation into the ambient environment could result in inefficient cryocooler operation and/or cryocooler shut down. U.S. Pat. No. 6,311,498, entitled “Tower mountable cryocooler and HTSC filter system,” addresses one method of dealing with heat dissipation in HTS filter systems. The disclosure of the '498 patent is expressly and fully incorporated herein by reference.

Additionally, current communications base station designs may implement a remoteable functionality. Remoting the RF presence allows system operators to maximize RF signal reception by placing transmitter/receiver front ends near or within areas having a greater concentration of users. For example, a central base station may communicate with several remote receiver front end units dispersed within a coverage range in order to provide a low cost remote RF presence. Current communications systems that incorporate remote front ends require suitable links, such as, e.g., fiber optic links or more conventional links including ethernet cabling, to connect the front ends to the base station. Additionally, current remoteable systems, some of which downconvert received signals prior to transport, experience signal degradation. Remoteable systems may be outdoor telecommunications systems wherein a number of front ends are dispersed at various locations away from a central base station. Another type of a remote system is an in-building system that uses remote front ends and antennas distributed throughout the building, all of which are connected to a central base station. The current in-building remote systems may or may not implement a downconversion step at the antenna/front end. Unfortunately, the current in-building systems suffer from very poor interference protection.

Accordingly, those skilled in the art would find a communications system with remote front end units that does not require downconversion prior to transport of a received signal to be useful. Those skilled in the art would further find both an in-building remote communications system and any remoteable communications system with improved interference protection to be useful.

### SUMMARY OF THE INVENTION

The present invention is directed to methods and systems for transmitting and receiving telecommunications signals. More particularly, the present invention is directed to a communications system having a remoteable functionality.

In one aspect of the present invention, a remoteable communications system is provided that includes a plurality of transmitter/receiver front end units coupled to a base station using an optical transmission path or other suitable transmission path. Each transmitter/receiver front end unit may be disposed at a remote location relative to the base station. Also, each transmitter/receiver front end unit may include a transmit side subsystem and an HTS receive side subsystem.

The transmit side subsystem may include a transmit filter coupled to a power amplifier. The transmit filter may be a non-superconducting filter, and may be incorporated with a duplexer or multiplexer. The HTS receive side subsystem may include a cryogenic enclosure and a cryocooler coupled to the cryogenic enclosure. The cryocooler may be any suitable cryocooler, such as, e.g., a Stirling cycle cryocooler, a Brayton cycle cryocooler, a Gifford-McMahon cryocooler, and a pulse tube cryocooler. The receive side subsystem may also include an HTS filter disposed within the cryogenic enclosure, and a low noise amplifier located within the enclosure. The HTS filter may be a thin-film superconductor filter, such as, e.g., YBCO or a thallium-based superconductor. Alternatively, the HTS filter may be a thick-film superconductor filter.

Additionally, the receive side subsystem incorporates a non-linear modulator, and may include a low noise amplifier coupled to the non-linear modulator. The non-linear modulator may be a RF to light modulator. Further, a de-modulator may be disposed within the base station to revert a modulated signal to RF.

A combined transmitter/receiver antenna may be provided, along with a first multiplexer coupled to the antenna, the transmitter side subsystem, and the receiver side subsystem, and a second multiplexer coupled to the transmitter side subsystem, the receiver side subsystem, and the optical transmission path.

In another aspect of the present invention, another remoteable communications system is provided that includes a plurality of transmitter/receiver front end units located remotely from a base station, an optical transmission path or other suitable path between a base station and each transmitter/receiver front end unit, and a base station configured to process signals to and from the plurality of transmitter/receiver front end units. The transmission path may be a fiber optic cable. Each front end unit may include a transmit side subsystem and an HTS receive side subsystem.

The HTS receive side subsystem may include a cryogenic enclosure, a cryocooler coupled to the cryogenic enclosure, an HTS filter disposed within the cryogenic enclosure, a low noise amplifier, and a non-linear modulator coupled to the low noise amplifier. The non-linear modulator, which may be a RF to light modulator, is coupled to the transmission path, and a corresponding de-modulator may be provided in the base station. The HTS receive side subsystem may optionally include a cooled low noise amplifier disposed within the cryogenic enclosure.

In another aspect of the present invention, another remoteable communications system is provided that includes a plurality of front end units, and each front end unit may have a cryogenic enclosure, a cryocooler coupled to the cryogenic enclosure, an HTS filter disposed within the cryogenic enclosure, a low noise amplifier, and a non-linear modulator coupled to the low noise amplifier. The non-linear modulator is coupled to a transmission path. The non-linear modulator may be a RF to light modulator. The transmission path, which may be a fiber optic cable, links a base station with each front end. The base station is configured to process signals to and from the plurality of front end units, and may include a de-modulator. Each front end unit may optionally include a cooled low noise amplifier disposed within the cryogenic enclosure. As with the other systems of the present invention, each front end unit may be located remote from the base station.

In another aspect of the present invention, a method for processing RF signals is provided. A RF signal is received at a front end unit. The RF signal is filtered using an HTS filter, and then amplified using a cooled low noise amplifier. The RF signal is next modulated in light using a non-linear modulator, and then relayed to a base station using a transmission path, which may be a fiber optic cable. The modulation of the RF signal may be accomplished using a RF to light modulator as the non-linear modulator. Additionally, the signal may be de-modulated at the base station. Further, a plurality of front end units may be distributed at locations remote from the base station. These remote locations may be within a building, or may be at various outdoors locations within the coverage area of the system.

Other objects and features of the present invention will become apparent from consideration of the following description taken in conjunction with the accompanying drawings.

### DESCRIPTION OF THE DRAWINGS

FIG. 1 illustrates a transmitter/receiver front end in accordance with the present invention.

FIG. 2 illustrates another transmitter/receiver front end in accordance with the present invention.

FIGS. 3A and 3B illustrate additional front ends in accordance with the present invention.

FIG. 4 illustrates a remoteable communications system in accordance with the present invention.

### DETAILED DESCRIPTION

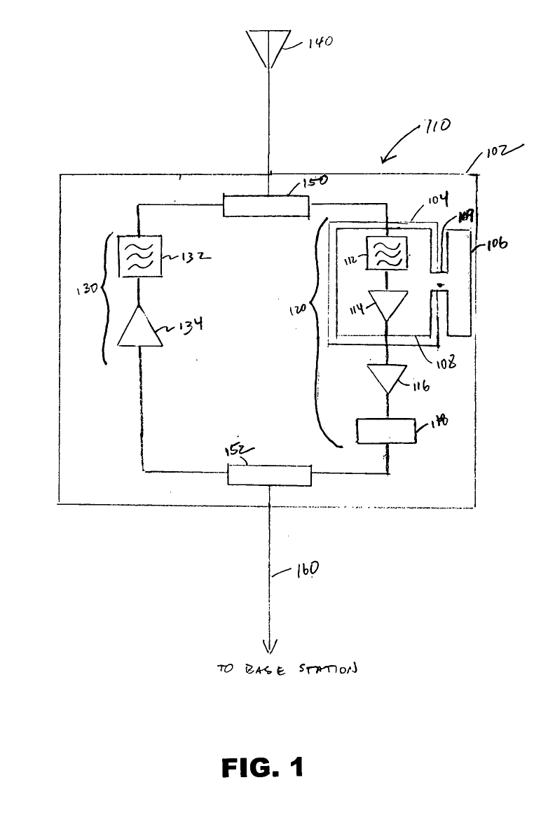

FIG. 1 illustrates an HTS transmitter/receiver front end unit 110 usable with a communications system according to the present invention. The communications system is preferably remoteable or has a distributed architecture wherein at least one transmitter/receiver front end units 110 is placed at some distance away from a main base station. For example, in an outdoor setting, a plurality of transmitter/receiver front end units 110 may be installed at various locations within a coverage area, and then connected to a single, main base station. As another example, for an in-building arrangement, a plurality of transmitter/receiver front end units 110 may be installed at various locations within the building, and then connected to a main base station.

The transmitter/receiver front end unit 110 preferably includes an environmentally protective system housing 102. The housing 102 contains a transmit side subsystem 130 and a receive side subsystem 120. The housing 102 is designed to isolate the transmitter/receiver unit 110 from ambient forces. Any suitable housing that insulates the transmitter/receiver front end unit 110 from external forces and/or inclement weather may be used for the housing 102. The housing 102 may be mounted to a desired location, such as, e.g., a tower, a location within a building, or an outside or pole mount, using any suitable attachment means, such as, e.g., brackets, placement on a platform, being formed as an integral part of the tower or building, or the like.

As previously noted, the transmit side subsystem 130 is located within the housing 102. Preferably, the transmit side subsystem 130 includes a transmit filter 132 and a power amplifier 134. In this embodiment of the transmitter/receiver front end unit 110, the transmit filter 132 is a conventional, non-superconducting filter. The transmit filter 132 is coupled to an antenna side multiplexer 150, which, in turn, is coupled to an antenna 140. Transmitted signals originating from transmit electronics in the base station are relayed to the transmit side subsystem 130 using a transmission path 160. The transmission path 160 may be optical such as, e.g., a fiber optic cable. Alternatively, the transmission path 160 may be a wireless communications path. In another alternative, the transmission path 160 may be a conventional path such as, e.g., ethernet cabling. The transmit side subsystem 130 amplifies and filters the transmit signal, and then broadcasts the signal into a coverage area via the antenna 140.

Because the transmitter/receiver front end unit 110 utilizes a common antenna 140 to both transmit and receive signals, multiplexers 150, 152 are provided. A base station side multiplexer 152 processes transmit signals being relayed from the base station to the transmit side subsystem 130 and receive signals being relayed from the receive side subsystem 120 to the base station. The antenna side multiplexer 150 processes transmit signals being relayed from the transmit side subsystem 130 to the antenna 140 and receive signals being relayed from the antenna 140 to the receive side subsystem 120. As illustrated, the transmit filter 132 and the antenna side multiplexer 150 are discrete components. In an alternative embodiment, the transmit filter 132 is incorporated within the antenna side multiplexer 150, and is not a separate component.

The receive side subsystem 120 is located within the housing 102. The receive side subsystem 120 is preferably an HTS-based RF front end receiver that incorporates both an HTS filter 112 and a cooled low noise amplifier 114 (LNA). In an alternative embodiment, the receive side subsystem 120 does not include a cooled LNA. Turning back to FIG. 1, although one HTS filter 112 and one cooled LNA 114 is shown, a plurality of HTS filters 112 and a plurality of cooled LNAs 114 may be incorporated into the receive side subsystem 120. The receive side subsystem 120 further includes a cryocooler 106 that is used to cool the HTS filter 112 and cooled LNA 114, and possibly other electronic components that may be incorporated into the receive side subsystem 120.

The HTS filter 112 is preferably manufactured from a thin-film superconductor, although the present invention also contemplates other constructions such as thick-film superconductors. The thin-film superconductor may, for example, comprise a yttrium containing superconductor known generally as YBCO superconductors, or, alternatively, a thallium-based superconducting compound. U.S. Pat. No. 5,358,926, entitled, “Epitaxial thin superconducting thallium-based copper oxide layers,” discloses exemplary thin-film superconductors that may be used with the present invention. The disclosure of the '926 patent is fully and expressly incorporated by reference herein. The invention is not, however, limited to a particular type or class of superconductors, i.e., any HTS superconductor that will properly filter RF signals at HTS temperatures may be used in constructing the HTS filter 122.

The cryocooler 106 included within the receive side subsystem 120 may be any suitable cryocooler, such as, e.g., a Stirling cycle cryocooler, a Brayton cycle cryocooler, a Gifford-McMahon cryocooler, a pulse tube cryocooler, and the like. Exemplary cryocoolers are disclosed in U.S. Pat. No. 6,327,862, entitled, “Stirling cycle cryocooler with optimized cold end design,” and U.S. Pat. No. 6,141,971, entitled “Cryocooler motor with split return iron.” The disclosures of the '862 and the '971 patents are fully and expressly incorporated herein by reference. U.S. Pat. No. 6,311,498, entitled “Tower mountable cryocooler and HTSC filter system,” and which has already been incorporated by reference, also discusses cryocoolers suitable for use with the present invention.

The cryocooler 106 is thermally coupled at its cold end to a cryogenic enclosure 104 that contains the HTS components and other electronics. The cryogenic enclosure 104 is preferably a vacuum dewar. The use of a vacuum dewar for the cryogenic enclosure 104 minimizes the transfer of heat from the external environment to the inside of the cryogenic enclosure 104.

A cold stage 108 is preferably located within the cryogenic enclosure 104. The cold stage 108 preferably contains thereon the HTS filter 112 and the cooled LNA 114. Optionally, other electronic components that are used in the receive side subsystem 120 may also be located upon the cold stage 108. As noted, in an alternative embodiment the receive side subsystem 120 does not include a cooled LNA 114. The cold stage 108 may have a single face or a plurality of faces to hold a number of HTS filters 112 and cooled LNAs 114. A cooling transfer segment 109 couples the cold stage 108 with the cryocooler 106. The cooling transfer segment 109, which may be referred to as a cold finger, facilitates thermal transfer between the cold stage 108 and the cryocooler 106.

In general, a RF signal is received by the antenna 140 and transmitted to the antenna side multiplexer 150, which then relays the signal to the receive side subsystem 120. Once received by the receive side subsystem 120, the RF signal, i.e., the received signal, is filtered by the HTS filter 112, and is amplified by the cooled LNA 114 if a cooled LNA 114 is included in the subsystem 120. Again, as previously noted, in an alternative embodiment, the receive side subsystem 120 does not include the cooled LNA 114.

The receive side subsystem 120 also includes a high gain low noise amplifier 116 configured to accept a RF signal that has already been processed by the HTS filter 112 and, if included, the cooled LNA 114. The high gain LNA 116 is coupled to a non-linear modulator 118. The non-linear modular 118 may be, for example, a RF to light modulator. As illustrated, the high gain LNA 116 and the non-linear modulator 118 are disposed outside of the cryogenic enclosure 104.

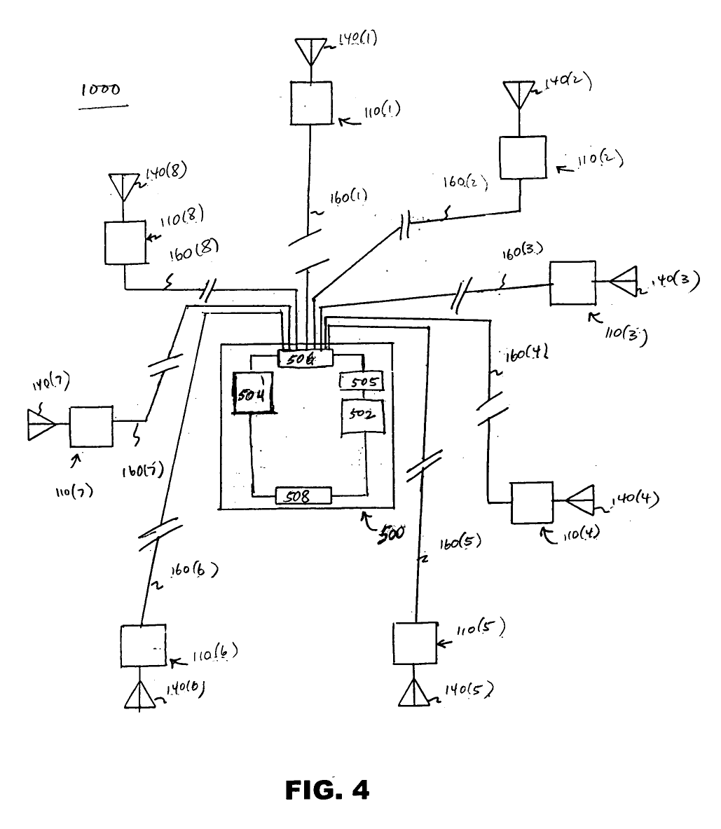

By incorporating the non-linear modulator 118 and the high gain LNA 116, the receive side subsystem 120 is configured to receive a RF signal, and convert the signal using the non-linear modulator 118 to a format suitable for transport via the optical transmission path 160. For example, the non-linear modulator 118 may modulate a RF signal to light, which is subsequently transported via the optical transmission path 160 to the base station. The high gain LNA 116 compensates for possible loss in signal strength due to the conversion process, and also compensates for loss along the transmission path 160 between the base station and the receive side subsystem 120. At the base station, the signal may be converted back to RF using a de-modulator 505 (best seen in FIG. 4). Using this arrangement, down conversion of the signal is performed at the base station, i.e., after modulation and transport of the signal from the receive side subsystem 120 to the base station.

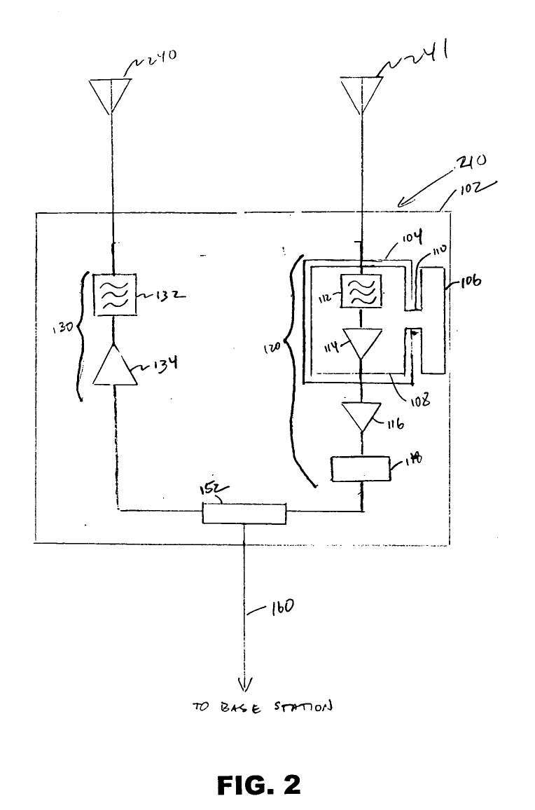

Turning to FIG. 2, another embodiment of an HTS transmitter/receiver front end unit 210 suitable for use with a communications system of the present invention is illustrated. To the extent the HTS transmitter/receiver front end unit 210 incorporates parts also used in the HTS transmitter/receiver front end unit 110, common reference numerals are used to identify those parts. The HTS transmitter/receiver front end unit 210 operates in a similar manner as the HTS transmitter/receiver front end unit 110, and reference is made to the description of the operation of front end unit 110, except that front end unit 210 does not include a single, common transmitter/receiver antenna 140, and therefore does not require the use of an antenna side multiplexer 150. Instead, the transmitter/receiver front end unit 210 incorporates a transmitter antenna 240 and a receiver antenna 241, which are coupled to the transmit side subsystem 130 and the receive side subsystem 120, respectively. Accordingly, transmit signals and receive signals travel directly between the transmit side subsystem 130 and the transmitter antenna 240 and the receive side subsystem 120 and the receiver antenna 241.

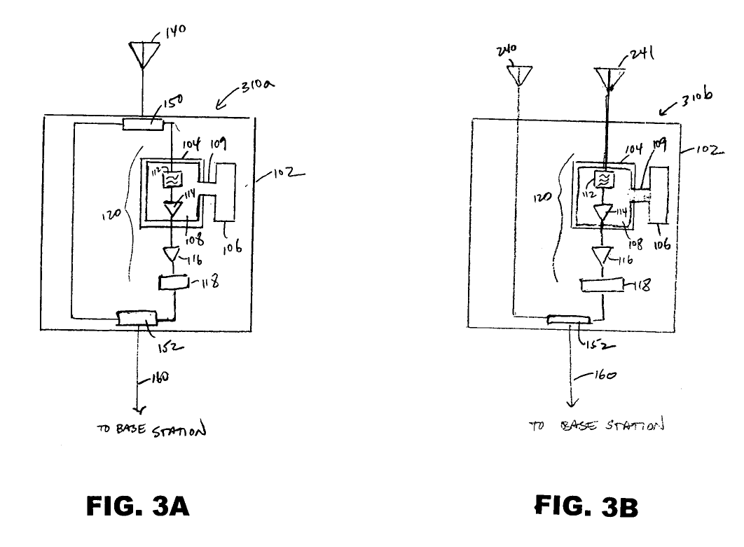

Turning to FIG. 3A, a receiver front end unit 310a usable with a communications system of the present invention is illustrated. Unlike the transmitter/receiver front end units 110, 210, receiver front end unit 310a includes only the receive side subsystem 120, and does not incorporate a transmit side subsystem. Because the front end unit 310a does not incorporate a transmit side subsystem, the front end unit 310a must be used in conjunction with a communication system wherein the transmit side subsystem is housed within a base station.

The receive side subsystem 120 of receiver front end unit 310a uses components common with the receive side subsystems 120 of transmitter/receiver units 110, 210. Accordingly, common reference numerals are used to identify those parts, and reference is made to the discussion of the operation of the receive side subsystem 120 of transmitter/receiver front end units 110, 210, as that discussion also applies to the receive side subsystem 120 of receiver front end unit 310a. For example, the receive side subsystem 120 of receiver front end unit 310 may include an HTS filter 112 and a cooled LNA 114 disposed on a cold stage 108. The cold stage 108, HTS filter 112, and cooled LNA 114 may all be disposed within a cryogenic enclosure 104, and a cooling transfer segment 109 may couple the cold stage 108 with a cryocooler 106. Alternatively, the receive side subsystem 120 may omit the cooled LNA 114. The receive side subsystem 120 further includes a non-linear modulator 118 to modulate a received RF signal in light prior to relaying that signal to a base station using a transmission path 160. The receive side subsystem 120 is shown with a LNA 116 to amplify the signal prior to modulation of the signal with the non-linear modulator 118. Additionally, as with front end unit 110, front end unit 310a utilizes a combined transmit/receive antenna 140. Accordingly, a base station side multiplexer 152 and an antenna side multiplexer 150 may be provided with front end unit 310a.

Illustrated in FIG. 3B is another receiver front end unit 310b usable with a communications system of the present invention. Like front end unit 310a, receiver front end unit 310b includes only receive side subsystem components, and does not incorporate a transmit side subsystem. Front end unit 310b includes similar components as front end units 110, 210, 310a, and common reference numbers are used to identify those components. Reference is also made to the description of those components as the mode of operation of front end unit 310b is similar. Front end unit 310b differs from front end unit 310a in that front end unit 310b includes a separate transmit antenna 240 and receive antenna 241. Accordingly, as with front end unit 210, front end unit 310b includes a base station side multiplexer 152, but does not require an antenna side multiplexer 150.

Turning now to FIG. 4, FIG. 4 illustrates one embodiment of a remoteable/distributed communications system 1000 according to the present invention. As shown, communications system 1000 includes a plurality of transmitter/receiver front end units 110(1 to n) installed at a plurality of locations in a coverage area. It will be appreciated that transmitter/receiver front end units 210 and front end units 310a, 310b may be utilized in lieu of transmitter/receiver front end units 110. Accordingly, references in this description of system 1000 to front end units 110 will be understood to also apply to front end units 210, 310a, and 310b.

Although the system 1000 is shown with eight transmitter/receiver front end units 110, which are identified as 110(1) to 110(8), it will be appreciated that either a greater number or smaller number of transmitter/receiver front end units 110 may be included with system 1000. The system 1000 will include at least one front end unit 110. Turning back to FIG. 4, the plurality of transmitter/receiver front end units 110(1 to 8) are coupled to a main base station 500. In one embodiment, because the down-conversion of a received signal is accomplished after modulation and transport of the RF signal, a de-modulator 505 is provided in the base station 500 to revert the optical signal back to RF.

Each transmitter/receiver front end unit 110(1 to 8) is also preferably coupled to a corresponding combined transmit/receive antenna 140(1 to 8). In an alternative embodiment of system 1000 in which transmitter/receiver units 210 or front end units 310b are utilized rather than transmitter/receiver front end units 110, separate transmit 240 and receive 241 antennas would be provided for each front end unit.

System 1000 is not limited to tower mounted installations. Rather, each transmitter/receiver front end unit 110(1 to 8) is mountable at various locations within the coverage area, and at locations within the coverage area that are remote from the main base station 500. Moreover, each transmitter/receiver front end unit 110(1 to 8) is preferably located in proximity to the users of the system 1000. Exemplary locations for placement of a transmitter/receiver front end unit 110(1 to 8) include, e.g., at various locations within a building, within the interior space of the walls of a building, on street lamps, on billboards, on street signs, and the like. Each transmitter/receiver front end unit 110(1 to 8) is coupled to the main base station 500 via a transmission path 160(1 to 8).

The system 1000 is particularly useful for telecommunications systems that incorporate standards such as 3G. For example, system 1000 provides for a plurality of “underlay” units, which are the transmitter/receiver front end units 110(1 to 8), for a 3G system, and places the underlay units closer to the users of the system. Because the antennas 140(1 to 8) coupled to the transmitter/receiver front end units 110(1 to 8) are located closer to the users, the attenuation of the signals processed by the system 1000 decreases. The probability of interfering signals from competitive systems increases, however, because the transmitter/receiver front end units 110(1 to 8) may also be located closer to the users of those systems. The use of superconducting materials within the transmitter/receiver front end units 110(1 to 8), and particularly within the receive side subsystems 120, operates to minimize and eliminate these interfering signals. For example, in telecommunications systems implementing 3G standards, competitors' signals are close in frequency, and the use of superconducting materials within the transmitter/receiver front end units 110(1 to 8) allows system 1000 to filter out competitors' signals with greater efficiency and effect than systems that do not incorporate superconducting materials.

The front end units 110(1 to 8) are coupled to a base station 500. In addition to the de-modulator 505, the base station 500 includes receive electronics unit 502 and transmit electronics unit 504 coupled to the receive side subsystem 120 and the transmit side subsystem 130, respectively, of each front end unit 110. The receive electronics unit 502 and the transmit electronics unit 504 process received signals and generate transmission signals, respectively. The receive electronics unit 502 and the transmit electronics unit 504 may incorporate digital-analog converters, analog-digital converters, up-converters, down-converters, and the like. In an embodiment of system 1000 wherein front end units 310a or 310b are coupled to the base station 500, the base station 500 further includes a transmit side subsystem 130, including a transmit filter 132 and a power amplifier 134, coupled to or incorporated within the transmit electronics unit 504.

A multiplexer 506 may be provided within the base station 500 in order to direct signals to/from the receive electronics 502 and transmit electronics 504. The multiplexer 506 is also coupled to each optical transmission path 160(1 to 8) that is coupled to the transmitter/receiver front end units 110(1 to 8). Consequently, the multiplexer 506 is configured to relay signals between the transmitter/receiver front end units 110(1 to 8) and the receive and transmit electronics 502, 504. A power distribution unit 508 may also be coupled to the receive and transmit electronics units 502, 504 in order to monitor and balance the signal strengths of the transmitted and received signals to maximize the coverage area of the system 1000. An exemplary process employed by the power distribution unit 508 to maximize the coverage area of the system 1000 is disclosed in U.S. Patent Application Publication No. US 2002/0183011 A1, which is expressly incorporated by reference. The components located within the base station 500, including the receive electronics unit 502, the transmit electronics unit 504, and the power distribution unit 508, may be incorporated into a single, main electronics unit, or may be maintained as discrete individual components.

While the invention is susceptible to various modifications and alternative forms, specific examples thereof have been shown in the figures and are described herein in detail. It should be understood, however, that the invention is not to be limited to the particular forms, systems, or methods disclosed. Furthermore, other aspects and embodiments of the invention will be apparent to those skilled in the art from consideration of the specification and practice of the invention disclosed herein. The invention is intended to cover all modifications, equivalents, and alternatives falling within the spirit and scope of the appended claims.

1. A remoteable communications system, comprising:
a plurality of transmitter/receiver front end units, each front end unit comprising
a transmit side subsystem; and
an HTS receive side subsystem comprising a cryogenic enclosure, a cryocooler coupled to the cryogenic enclosure, an HTS filter disposed within the cryogenic enclosure, a first low noise amplifier disposed within the cryogenic enclosure, and a non-linear modulator, wherein the non-linear modulator is coupled to a transmission path; and
a transmission path between a base station and each transmitter/receiver front end unit.

2. The system of claim 1, further comprising a base station configured to process signals to and from the plurality of transmitter/receiver front end units.

3. The system of claim 1, further comprising a second low noise amplifier coupled to the non-linear modulator and the first low noise amplifier.

4. The system of claim 3, wherein the second low noise amplifier is a high gain low noise amplifier.

5. The system of claim 1, wherein the non-linear modulator of each HTS receive side subsystem comprises a RF to light modulator.

6. The system of claim 1, wherein the cryocooler comprises a cryocooler chosen from the group consisting of a Stirling cycle cryocooler, a Brayton cycle cryocooler, a Gifford-McMahon cryocooler, and a pulse tube cryocooler.

7. The system of claim 1, further comprising a de-modulator disposed within the base station, wherein the de-modulator is configured to revert a modulated signal to RF.

8. The system of claim 1, wherein the transmit side subsystem comprises a transmit filter coupled to a power amplifier.

9. The system of claim 8, wherein the transmit filter is a non-superconducting filter.

10. The system of claim 1, wherein the HTS filter comprises a thin-film superconductor filter.

11. The system of claim 10, wherein the superconductor comprises YBCO.

12. The system of claim 10, wherein the superconductor comprises a thallium-based superconductor.

13. The system of claim 1, wherein the superconductor comprises a thick-film superconductor filter.

14. The system of claim 1, wherein each transmitter/receiver front end unit is disposed at a remote location relative to the base station.

15. The system of claim 1, comprising:
a combined transmitter/receiver antenna; and
a first multiplexer coupled to the antenna, the transmitter side subsystem, and the receiver side subsystem.

16. The system of claim 15, wherein the transmit side subsystem comprises a transmit filter that is incorporated into the first multiplexer.

17. The system of claim 15, further comprising a second multiplexer coupled to the transmit side subsystem, the receiver side subsystem, and the transmission path.

18. The system of claim 1, wherein the transmission path is an optical transmission path.

19. The system of claim 18, wherein the optical transmission path is a fiber optic cable.

20. The system of claim 1, wherein the transmission path comprises ethernet cabling.

21. A remoteable communications system, comprising:
a plurality of transmitter/receiver front end units, each front end unit comprising
a transmit side subsystem; and
an HTS receive side subsystem comprising a cryogenic enclosure, a cryocooler coupled to the cryogenic enclosure, an HTS filter disposed within the cryogenic enclosure, and a non-linear modulator, wherein the non-linear modulator is coupled to a transmission path; and
a transmission path between a base station and each transmitter/receiver front end unit.

22. The system of claim 21, wherein the HTS receive side subsystem further comprises a low noise amplifier coupled to the non-linear modulator.

23. The system of claim 22, wherein the low noise amplifier is a cooled low noise amplifier disposed within the cryogenic enclosure.

24. The system of claim 22, wherein the HTS receive side subsystem further comprises a second low noise amplifier coupled to the non-linear modulator.

25. The system of claim 24, wherein the second low noise amplifier is a high gain low noise amplifier.

26. The system of claim 21, wherein the non-linear modulator comprises a RF to light modulator.

27. The system of claim 21, further comprising a de-modulator disposed within the base station.

28. The system of claim 21, wherein each transmitter/receiver front end unit is located remote from the base station.

29. The system of claim 21, wherein the transmission path comprises an optical transmission path.

30. The system of claim 29, wherein the optical transmission path comprises a fiber optic cable.

31. The system of claim 21, wherein the transmission path comprises ethernet cabling.

32. The system of claim 21, further comprising a base station configured to process signals to and from the plurality of transmitter/receiver front end units.

33. A remoteable communications system, comprising:
a plurality of front end units, each front end unit comprising
a cryogenic enclosure,
a cryocooler coupled to the cryogenic enclosure,
an HTS filter disposed within the cryogenic enclosure,
a low noise amplifier,
a non-linear modulator coupled to the low noise amplifier, wherein the non-linear modulator is coupled to a transmission path, and
a transmission path between a base station and the front end unit; and
a base station configured to process signals to and from the plurality of front end units.

34. The system of claim 33, wherein the low noise amplifier is a high gain low noise amplifier.

35. The system of claim 33, wherein each front end unit further comprises a second low noise amplifier, wherein the second low noise amplifier is disposed within the cryogenic enclosure.

36. The system of claim 33, wherein the non-linear modulator comprises a RF to light modulator.

37. The system of claim 33, further comprising a de-modulator disposed within the base station.

38. The system of claim 33, wherein each front end unit is located remote from the base station.

39. The system of claim 33, wherein the transmission path comprises an optical transmission path.

40. The system of claim 39, wherein the optical transmission path comprises fiber optic cable.

41. The system of claim 33, wherein the transmission path comprises ethernet cabling.

42. The system of claim 33, wherein each front end unit further comprises a transmit side subsystem having a transmit filter.

43. A method for processing RF signals, comprising:
receiving a RF signal at a front end unit;
filtering the RF signal using an HTS filter;
amplifying the RF signal using a cooled low noise amplifier;
modulating the RF signal in light using a non-linear modulator; and
relaying the RF signal to the base station using a transmission path.

44. The method of claim 43, wherein the non-linear modulator comprises a RF to light modulator.

45. The method of claim 43, further comprising:
distributing a plurality of front end units at locations remote from the base station.

46. The method of claim 45, wherein the locations are within a building.

47. The method of claim 45, wherein the locations are outdoors.

48. The method of claim 43, wherein the transmission path comprises an optical transmission path.

49. The method of claim 48, wherein the optical transmission path comprises a fiber optic cable.

50. The method of claim 43, wherein the transmission path comprises ethernet cabling.

51. The method of claim 43, further comprising after relaying the RF signal to the base station:
de-modulating the RF signal.

52. A remoteable communications system, comprising:
a front end unit comprising a cryogenic enclosure, a cryocooler coupled to the cryogenic enclosure, an HTS filter disposed within the cryogenic enclosure, a low noise amplifier, a non-linear modulator coupled to the low noise amplifier, wherein the non-linear modulator is coupled to a transmission path, and a transmission path between a base station and the front end unit; and
a base station configured to process signals to and from the front end unit.

53. The system of claim 52, wherein the low noise amplifier is a high gain low noise amplifier.

54. The system of claim 53, wherein the front end unit further comprises a second low noise amplifier, wherein the second low noise amplifier is disposed within the cryogenic enclosure.

55. The system of claim 52, wherein the non-linear modulator comprises a RF to light modulator.

56. The system of claim 52, further comprising a de-modulator disposed within the base station.

57. The system of claim 52, wherein the front end unit is located remote from the base station.

58. The system of claim 52, wherein the transmission path comprises an optical transmission path.

59. The system of claim 58, wherein the optical transmission path comprises fiber optic cable.

60. The system of claim 52, wherein the transmission path comprises ethernet cabling.

61. The system of claim 52, wherein the front end unit further comprises a transmit side subsystem having a transmit filter.
